(19) United States
(12) Patent Application Publication
(10) Pub. No.: US 2003/0226153 A1
(43) Pub. Date: Dec. 4, 2003

(54) Method and apparatus for switching television channels

(75) Inventors: David H. Bessel, Poway, CA (US); Christopher Jensen Read, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignees: Sony Corporation, a Japanese corporation; Sony Electronics Inc., a Delaware corporation

(21) Appl. No.: 10/164,141

(22) Filed: Jun. 4, 2002

(51) Int. Cl. H04N 7/16; G06F 3/00; H04N 5/445; H04N 5/50; G06F 13/00

(52) U.S. Cl. 725/152; 725/56; 348/731

(57) ABSTRACT

A system for switching television channels provides a first tuner by which a first television channel is received and a second tuner by which a second television channel is received once a channel selection is made while the first channel is being viewed. The current channel being viewed is immediately switched to the selected second channel once the second tuner has acquired that channel.

### BACKGROUND OF THE INVENTION

The present invention relates to television channel switching, and more particularly to television channel switching in digital television. Even more particularly, the present invention relates to the relatively large amount of time required and the display of blank or otherwise non-program periods in the switching of channels in digital television.

Television (TV) viewers perceive seamless, rapid switching from one channel to another to be an important TV receiver characteristic, and have become accustomed to seamless, rapid switching from one channel to another in analog television. This type of channel switching is generally effected by pressing a “channel up” (“up” or “+”) or “channel down” (“down” or “−”) key on a control (such as a remote control) for a television.

With the high number of channels now available to viewers for viewing, searching serially (e.g., in ascending or descending numerical order) through multiple channels quickly becomes desirable, so that viewers can find their desired programming in an efficient manner, without referring to a channel guide/schedule. This practice is known, in popular vernacular, as “channel surfing.” Switching to another channel (either sequentially, or directly, i.e., “randomly”) to view alternate programming during, for example, commercials is also desirable for many viewers.

As the number of channels available to viewers increases, due for example to the introduction of technologies such as digital television (DTV), the desirability of seamless, rapid switching between channels increases.

Unfortunately, however, it is well known in the art that certain properties of digital television (DTV) make channel switching times, i.e., the periods between the selection and display of channels, longer than the channel switching times of traditional analog television, regardless of whether such channel switching is sequential or “random.”

The longer channel switching time is due to several factors involved with processing a digital television signal. The primary one being that in digital television there is a reference frame transmitted to the television (via, for example, a coaxial cable transmission line, or air channel, such as, for example, a satellite channel) generally only every 0.5 seconds. These reference frames are used to help digitally tune to a desired “channel” by acquiring a correct frequency and timing for the desired “channel.” As a result, in some cases, the viewer is presented with a blank or otherwise non-program screen (display) for 1 second or more when switching channels.

Thus, there is a need for systems and methods that provide for channel switching (including “channel surfing”) in, for example, digital television, with reduced or eliminated blank or otherwise non-program displays during channel switching, and furthermore with a reduced or zero time delay (during which a non-program display is presented to the viewer) required for the switching channels.

The present invention advantageously addresses the above and other needs.

### SUMMARY OF THE INVENTION

The present invention addresses the above and other needs by providing a system and method for switching channels.

In one embodiment, the present invention can be characterized as a method in which a first channel is received by a first tuner, the first channel is displayed, a second channel is selected by a viewer, and the second channel is received by a second tuner while the first channel is being displayed.

In accordance with a variation of the one embodiment, the second tuner is, before the second channel is selected by the viewer, tuned to a next higher channel from first channel. In the event the second channel selected by the viewer is the next higher channel from the first channel, and after a prescribed time period for tuning of the second tuner to the second channel, the second channel can be immediately displayed upon being selected. In further accordance with this variation, once the second channel is selected by the viewer, the first tuner is, before a third channel is selected by the viewer, tuned to a next higher channel from the second channel.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram of a channel switching system in accordance with one embodiment of the present invention;

FIG. 2 is a block diagram of the channel switching system of FIG. 1 with one example of signal processing subsystems and interrelationships thereinbetween shown in detail;

FIG. 3 is a process flow chart showing a channel switching process of the channel switching system of FIG. 1 and FIG. 2;

FIG. 4A is a timeline showing switching between two tuners of the channel switching system of FIG. 1 and FIG. 2; and

FIG. 4B is a timeline showing switching of channels using one tuner of a prior art conventional channel switching system.

### DETAILED DESCRIPTION OF THE PREFERRED EMBODIMENTS

The following description is of the best mode presently contemplated for carrying out the invention. This description is not to be taken in a limiting sense, but is made merely for the purpose of describing the general principles of the invention. The scope of the invention should be determined with reference to the claims.

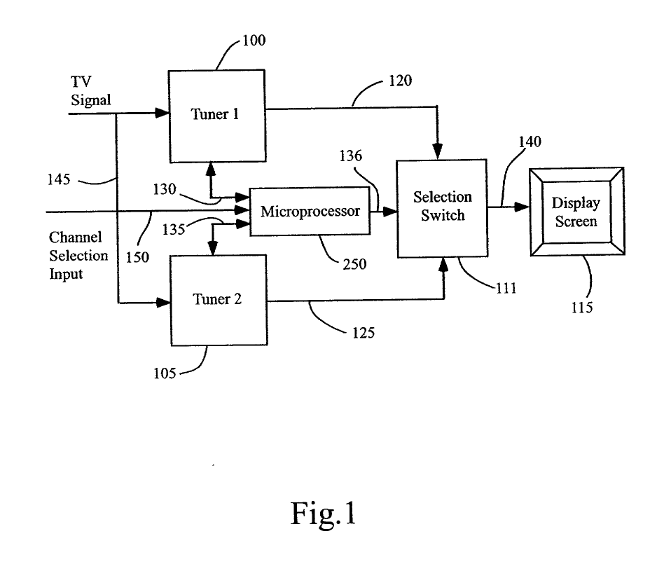

Referring to FIG. 1, shown is a block diagram of the channel switching system in accordance with one embodiment of the present invention. Shown is a first tuner 100, a second tuner 105, a microprocessor 250, a selection switch 111 and a display screen 115.

There is an RF television signal input 145 to the first and second tuners 100, 105 and a channel selection input 150 to the microprocessor 250. The first and second tuners 100, 105 are coupled 120, 125 to the selection switch 111. The tuners 100, 105 are also coupled to the microprocessor 250 individually through separate duplex communication lines 130, 135, respectively. The microprocessor 250 and display screen 115 are coupled 136, 140 to the selection switch 111.

The first tuner 100 and the second tuner 105 receive an RF television signal input 145. The microprocessor 250 controls which channels are tuned by the tuners 100, 105 and which output 120, 125 from each tuner 100, 105 is selected by the selection switch 111. The output 140 of the selection switch 111 (controlled by the microprocessor) is a television signal that is sent to the display screen 115 for display.

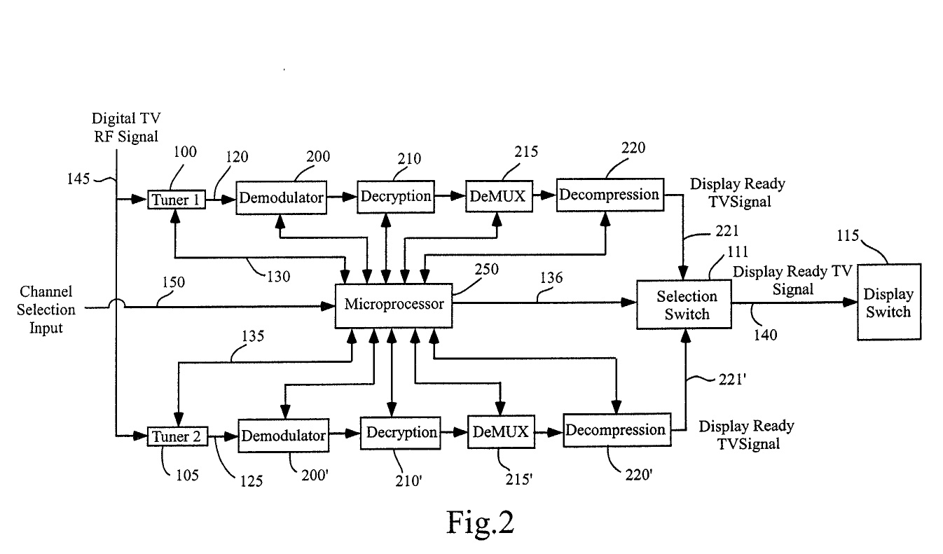

Referring next to FIG. 2, shown is a block diagram of the channel switching system of FIG. 1 with one example of signal processing subsystems and interrelationships thereinbetween shown in detail. Shown are two signal paths. Each of the two parallel signal paths is substantially identical (therefore the components thereof are commonly numbered, with callout numbers of the components of one path carrying the prime (“′”) indicator). In the interest of conciseness, only one of the two parallel signal paths is described hereinbelow, with the other of the two parallel signal paths being understood to be identical to the one of the two parallel signal paths, except as otherwise described or depicted. Each signal path includes a tuner 100, demodulator 200, a decryptor 210, a demultiplexer 215, and a video decompression module 220. Also shown is a single microprocessor 250, the selection switch 111 and display screen 115. Within each signal path, the tuner 100, demodulator 200, decryptor 210, demultiplexer 215 and decompression module 220 are individually coupled to the microprocessor 250 which is coupled 136 to the selection switch. Also, the tuner 100 is coupled to the demodulator 200 which is in turn coupled to the decryptor 210. The decryptor 210 is coupled to the demultiplexer 215 which is in turn coupled to the decompression module 220, and the decompression module 220 is coupled to the selection switch 111.

As explained above, the first tuner 100 and the second tuner 105 receive an RF television signal input 145. Two television programs are extracted from the television signal input 145 by two parallel signal paths depicted in FIG. 2. Each of the two parallel signal paths shown includes a demodulator 200, a decryptor 210 a demultiplexer 215 and a decompression device 220, as are known in the art. As the respective signals pass through these devices, the microprocessor 250 coordinates the signal processing to produce a demodulated, decrypted and demultiplexed program signal. The microprocessor 250 initiates and coordinates decompression of the video for each of the program signals. Once these signals are decompressed, the decompression devices 220, 220′ output these two signals 221, 221′ for selective display by the television display screen 115.

These two television signals 221, 221′ are input to a selection switch 111 that is coupled 136 to the microprocessor 250 having a channel selection input 150 as in FIG. 1, described above. The selection switch 111 is controlled by the microprocessor 250 which takes into account the value of the channel selection input 150 and operates according to the channel switching process described below. The output 140 of the selection switch 111 is the television signal selected by the selection switch 111 to be sent to the display screen 115 for display.

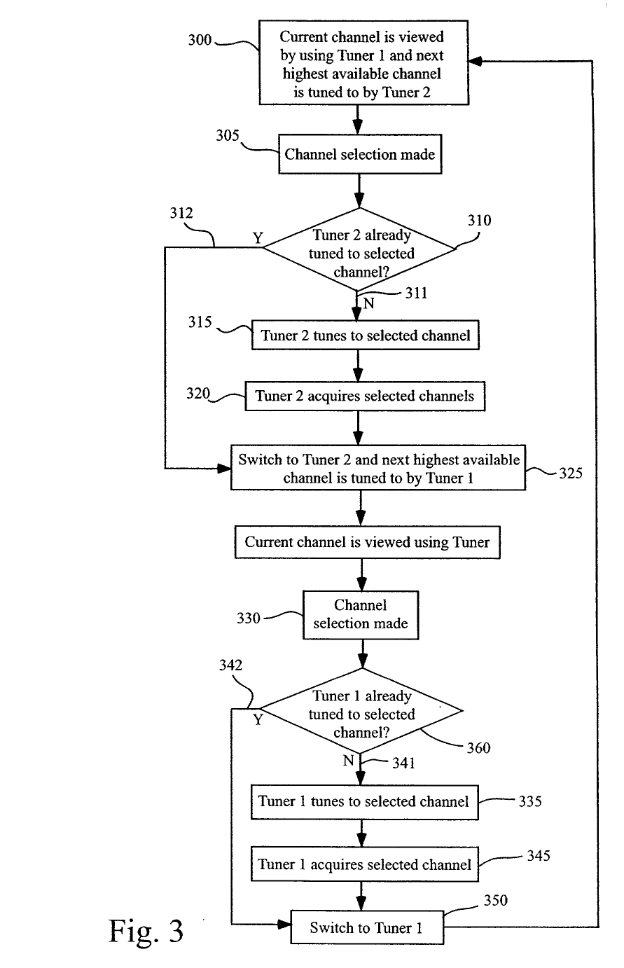

Referring now additionally to FIG. 3, shown is the channel switching process flow of the channel switching system of FIG. 1 and FIG. 2. Shown are blocks that represent the steps and decisions made during the channel switching process. The arrows point in order to the next step or decision to be made in the process.

By way of operation, a current channel is viewed 300 on the display screen 115 by receiving a signal 140 through the selection switch 111 ultimately from either the first tuner 100 or the second tuner 105, e.g., the first tuner 100 in this case. By default, the tuner through which the current channel is not being viewed, e.g., the second tuner 105 in this case, can be, for example, tuned 260 to the next highest available channel. This operation is controlled via the selection switch 111. By way of further example, the tuner through which the current channel is not being viewed, e.g., the second tuner 105, can be, for example, tuned to a channel selected as a function of one or more of the following: dwell time (i.e., the length of time during which the viewer has viewed the current channel); a preselected or programmatically determined (such as determined as a function of the viewer viewing habits, e.g., a statistical analysis of the most probable next channel to be selected by the viewer); time of day; day of week; a previously viewed channel (e.g., if the viewer selected the current channel sequentially or nonsequentially, such as from a numeric keypad). The channel selected may be alternatively or additionally determined as a function of a viewer's direction of sequentially tuning through channels, e.g., selecting a next higher channel for tuning by the tuner through which the current channel is not being viewed in the event the current channel was selected by pressing a “DOWN” button. The way in which the channel selected is determined, i.e., of what the channel selected is a function, may be automatically or manually adjusted as e.g., a function of user behavior or interaction.

When a channel selection is made 305, it is communicated to the microprocessor 250 via the channel selection input 150. If the second tuner 105 is already tuned to that channel 310, 312 (such as may be the case when the viewer is scrolling sequentially up through the channels), the microprocessor 250 communicates 136 to the selection switch 111 to immediately switch 325 the display screen 115 input 140 from the output 221 originating from the first tuner 100 to the output 221′ originating from the second tuner 105, thus effecting the channel change (channel switching). As a result, the channel selection is immediately reflected on the display screen 115.

If the second tuner 105 is not already tuned to that channel 311 the microprocessor 250 communicates the channel selection to the second tuner 105. The second tuner 105 then tunes 315 to the channel (which, as mentioned above may take up to one second or more). Then, after the second tuner 105 acquires 320 the channel and any corresponding signal processing is completed, the selection switch 111 switches 325 the display screen 115 input 140 from the output 221 originating from the first tuner 100 to the output 221′ originating from the second tuner 105, thus effecting the channel change. As a result, during the period it takes for the second tuner 105 to tune the channel 315, 320 the display screen 115 input 140 remains switched to the output 120 originating from the first tuner 100, and thus the display screen 115 does not appear blank or otherwise reflect non-program displays. Alternative embodiments also exist where the switch to the new channel can take place even though the tuning and signal processing are not complete. This would be, for example, in the case described above where the second tuner 105 is not already tuned to the channel communicated through the channel selection input. In this case a blank or non-program screen is seen for a period of time until the tuning and signal processing are complete.

In either case, in preparation for a subsequent channel selection, the microprocessor 250 then communicates to the first tuner 100 to tune to a next higher channel 325 after the channel to which the second tuner 105 is tuned. When another channel selection is made 330, the first tuner 100 will then tune to the desired channel 335, 341 (if not tuned already 340, 341 i.e., if the other channel is not the next higher channel). Then (in the present embodiment once the first tuner 100 has acquired 345 the desired channel, if necessary), the display screen 115 input 140 is switched 350 by the control module 110 to the output 120 originating from the first tuner 100.

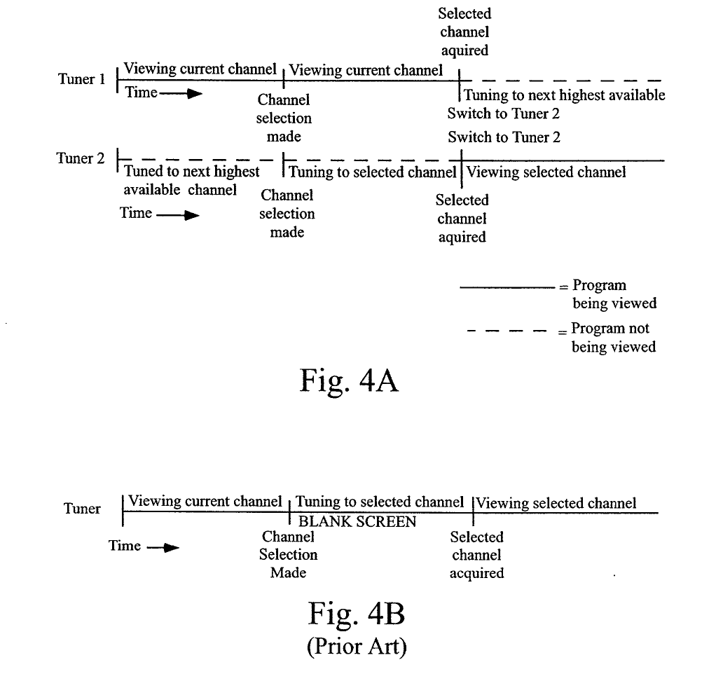

Referring next to FIG. 4A and FIG. 4B, shown in FIG. 4A is a timeline showing switching between two tuners of the channel switching system of FIG. 1 and FIG. 2. The state each is in at any given time is represented from left to right along the length of the horizontal line next to the name of the corresponding tuner. Shown in FIG. 4B is a timeline showing switching of channels using one tuner of a prior art conventional channel switching system. The state the tuner is in at any given time is represented from left to right along the length of the horizontal line.

As shown in FIG. 4A and FIG. 4B, the system and method of the present embodiment eliminates blank or otherwise non-program periods during channel switching, and reduces or eliminates the period between channel selection and display, i.e., reduces or eliminates the period required for channel switching (by “predicting” and “tuning to” a next channel, e.g., a next higher channel, with the tuner 100 or 105 to which the selection switch 111 is not switched).

As depicted in FIG. 4B, in conventional channel switching there is a blank or otherwise non-program period between selecting and displaying channels. This period results while the tuner (conventionally, a single tuner) tunes to and acquires the newly selected channel.

FIG. 4A shows that, in accordance with the present embodiment, while one tuner is tuning to a newly selected channel, a current channel is still being displayed using the other tuner, thus eliminating the blank or otherwise non-program period that would otherwise exist during channel switching.

Also, if the viewer selects a next highest available channel, say by scrolling up using a television remote control, the tuner through which the current program is not being viewed will, in accordance with one variation of the present embodiment, already be tuned to a next selected channel (i.e., next higher channel) and thus there will be no discernable switching time apparent to the viewer. This makes channel switching appear to the viewer to be virtually instantaneous (because the changing of the display from one channel to the next higher channel is nearly instantaneous).

While the invention herein disclosed has been described by means of specific embodiments and applications thereof, numerous modifications and variations could be made thereto by those skilled in the art without departing from the scope of the invention set forth in the claims.

For example, the embodiment and variation described above refer to tuning a first tuner to one channel for display, and tuning a second tuner to a next higher channel, so that in the event the user selects the next higher channel the change in the display from the one channel to the next higher channel can be nearly instantaneous. A further variation may include tuning the second tuner to a next lower channel in the event the viewer is “channel surfing” (sequentially tuning) down through channels, rather than sequentially up through channels, as assumed above.

Yet a further variation may include tuning the second tuner to a next higher/lower channel in a selected set of channels (channel group), such as, e.g., a news channel group.

And, yet another variation may include employing more sophisticated approaches and/or additional tuners to “predicting” a next channel to be selected, and then “tuning” to the next channel using the tuner 100 or 105, or additional tuners, the output of which is not being displayed on the display screen 115.

What is claimed is:

1. A method for switching television channels comprising the steps of:
receiving a first television channel by a first tuner and presenting the first channel from the first tuner on a display screen; and
switching to a different second channel such that there is neither a blank nor otherwise non-program display while switching channels.

2. The method of claim 1 wherein the switching step comprises the steps of:
selecting a second television channel;
tuning to the second television channel by a second tuner while the first tuner is receiving the first channel; and
switching to present on the display screen the second channel from the second tuner after the second tuner is tuned to the second channel.

3. The method according to claim 2 further comprising the steps of:
tuning to a predetermined channel by a tuner through which the current channel is not being viewed; and
switching to present on the display screen the predetermined channel from the tuner through which a current channel is not being viewed when the predetermined channel is selected for viewing.

4. The method according to claim 3 wherein the predetermined channel is a next highest channel from the current channel.

5. The method according to claim 3 wherein the predetermined channel is a next lowest channel from the current channel.

6. The method according to claim 3 wherein the predetermined channel is a previous channel viewed from the current channel.

7. The method according to claim 2 further comprising the steps of:
demodulating a television signal of a channel to be presented on the display screen before presenting the channel on the display screen;
demultiplexing the television signal of the channel to be presented before presenting the channel on the display screen;
decrypting the television signal of the channel to be presented before presenting the channel on the display screen;
decompressing the television signal of the channel to be presented before presenting the channel on the display screen; and
formatting the television signal of the channel to be presented before presenting the channel on the display screen.

8. The method according to claim 3 further comprising the steps of: demodulating a television signal of a channel to be presented on the display screen before presenting the channel on the display screen;
demultiplexing the television signal of the channel to be presented before presenting the channel on the display screen;
decrypting the television signal of the channel to be presented before presenting the channel on the display screen;
decompressing the television signal of the channel to be presented before presenting the channel on the display screen; and
formatting the television signal of the channel to be presented before presenting the channel on the display screen.

9. The method according to claim 8, further comprising the steps of:
demultiplexing video, graphics and text components of the television signal of the channel to be presented before encoding the television signal and presenting the channel on the display screen; and
decompressing the graphics and text components of the television signal of the channel to be presented before presenting the channel on the display screen and before encoding the television signal.

10. The method according to claim 9, further comprising the step of:
combining the video, graphics and text components of the television signal of the channel to be presented before encoding the television signal and presenting the channel on the display screen.

11. An apparatus for switching television channels comprising:
a television signal input means; and
means for switching to a selected channel coupled to the television signal input means operable such that there is neither a blank nor otherwise non-program display while switching channels.

12. The apparatus of claim 11, wherein the switching means comprises:
a first tuner having a first tuner output and a first tuner channel selection input;
a switch control module having a first channel signal input and a first channel selection output operably coupled to a first tuner output and a first tuner channel selection input, respectively; and
a second tuner having a second tuner output and a second tuner channel selection input operably coupled respectively to a second channel signal input and a second channel selection output of the switch control module, wherein the control module is operable for automatically switching a channel signal output of the switch control module to that of the first or second tuner output when the first or second tuner is tuned to a channel selected via a user channel selection input of the switch control module.

13. The apparatus of claim 12 wherein the switch control module is operable for automatically switching to present on a display screen, the display screen operably coupled to the channel signal output of the switch control module, a predetermined channel via a tuner already tuned to the predetermined channel when the predetermined channel is selected for viewing.

14. The appararus of claim 13 wherein the predetermined channel is a next highest channel from a current channel being viewed.

15. The appararus of claim 13 wherein the predetermined channel is a next lowest channel from a current channel being viewed.

16. The apparatus of claim 13 wherein the predetermined channel is a previous channel viewed from a current channel being viewed.

17. The apparatus of claim 12 further comprising an addtional tuner operably coupled to the switch control module wherein the switch control module is operable for automatically switching to present on a display screen, which is operably coupled to the channel signal output of the switch control module, a predetermined channel via any tuner operably coupled to the switch control module that is already tuned to the predetermined channel when the predetermined channel is selected for viewing.

18. The apparatus of claim 12 further comprising a plurality of tuners operably coupled to the switch control module wherein the switch control module is operable for automatically switching to present on a display screen, which is operably coupled to the channel signal output of the switch control module, a predetermined channel via any tuner operably coupled to the switch control module that is already tuned to the predetermined channel when the predetermined channel is selected for viewing.

19. The apparatus of claim 12 further comprising
a display screen operably coupled to the channel signal output of the switch control module.

20. The apparatus of claim 19 further comprising:
means for demodulating a television signal of a channel to be presented on the display screen operably coupled to the first and second tuners;
means for demultiplexing the television signal of the channel to be presented operably coupled to the demodulating means;
a microprocessor for initiating and coordinating decompression of video, graphics and text operably coupled to the demultiplexing means;
means for decrypting the television signal of the channel to be presented operably coupled to the microprocessor and the television signal demultiplexing means;
means for decompressing the television signal of the channel to be presented operably coupled to the microprocessor; and
means for formatting the television signal of the channel to be presented operably coupled to the decrypting means.

21. The apparatus of claim 20, further comprising:
means for demultiplexing video, graphics and text components of the television signal of the channel to be presented before encoding the television signal and presenting the channel on the display screen operably coupled to the decryption, microprocessor and decompression means;
means for decompressing the graphics and text components of the television signal of the channel to be presented before presenting the channel on the display screen and before encoding the television signal, the decompressing means operably coupled to the video, graphics and text demultiplexing means; and
means for combining the video, graphics and text components of the television signal of the channel to be presented before encoding the television signal and presenting the channel on the display screen, the video combining means being operably coupled to decompressing means, video graphics and text decompression means, the microprocessor and the encoding means.

22. A method for switching television channels comprising the steps of:
receiving a first television channel by a first tuner and presenting the first channel from the first tuner on a display screen;
tuning to a predetermined channel by a second tuner;
selecting a second television channel;
tuning to the second television channel by the second tuner if the second channel is different than the predetermined channel; and
presenting on the display screen, after the second channel is selected, a signal from the the second tuner even if the second tuner has not finished tuning to either the predetemined channel or the second channel.
